(19) United States
(12) Patent Application Publication
(10) Pub. No.: US 2013/0133325 A1
(43) Pub. Date: May 30, 2013

(54) POWER GENERATION DEVICE AND METHOD

(71) Applicant: Joe McCall, Atlanta, GA (US)

(72) Inventor: Joe McCall, Atlanta, GA (US)

(73) Assignee: MIP, LLC, Atlanta, GA (US)

(21) Appl. No.: 13/484,017

(22) Filed: May 30, 2012

Related U.S. Application Data
(60) Provisional application No. 61/491,686, filed on May 31, 2011.

(51) Int. Cl. F02G 1/04

(52) U.S. Cl. CPC F02G 1/04
USPC 60/645; 60/643

(57) ABSTRACT

A power generation device includes an enclosed circuit through which a working medium circulates. The working medium is heated at a first location in the enclosed circuit, and cooled at a second location. The differential heating and cooling causes the working medium to circulate within the enclosed circuit. The circulating medium is used to drive a turbine, which in turn may drive an electric generator.

This application claims priority from provisional U.S. patent application Ser. No. 61/491,686, filed May 31, 2011 and titled “Power Generation Device and Method”, the entire disclosure of which is hereby incorporated by reference herein for all purposes.

### BACKGROUND

Most electric power is generated in large centralized power plants using fossil or nuclear fuel. Water is heated to make steam, which is then used to turn a turbine, which in turn drives an electric generator. Modern combined-cycle power plants can operate at thermal efficiencies as high as about 60 percent, and can generate large amounts of electric power.

However, the large size and complexity of a commercial power plant also mean that such plants are very expensive, require long design and construction times, and are subject to regulatory scrutiny. Such plants also use large amounts of water for cooling. As the demand for power increases, and the world supply of fossil fuel is consumed, it is expected that alternative power generation technologies will be needed in the future, and that recovery of waste heat will be increasingly desirable.

### BRIEF SUMMARY

According to one aspect, a power generation system includes an enclosed circuit through which a working medium circulates. A heat source heats the working medium at a first location in the circuit, and a cooling mechanism cools the working medium at a second location in the circuit. The differential heating and cooling causes the working medium to circulate within the enclosed circuit. The system further includes a turbine driven by the circulating working medium. In some embodiments, the system further includes an electric generator driven by the turbine. In some embodiments, the system further includes a constriction through which the working medium passes, such that the velocity of the working medium is higher as it passes the turbine than in an unrestricted portion of the enclosed circuit. In some embodiments, the turbine includes a rotational axis transverse to the flow of the working fluid through the enclosed circuit, and the turbine includes a compression ring that prevents the working medium from flowing near the rotational axis of the turbine. The radius of the compression ring may be variable. The heat source may be a heat exchanger that imparts heat to the working medium from a heated fluid. In some embodiments, at least one portion of the enclosed circuit is insulated to mitigate heat loss to the ambient environment surrounding the system. In some embodiments, the cooling mechanism comprises an uninsulated portion of the enclosed circuit, to enable heat loss to the ambient environment surrounding the system. The working medium may be air.

According to another aspect, a method of generating electric power includes enclosing a working medium within an enclosed circuit, heating the working medium at a first location in the enclosed circuit, and cooling the working medium at a second location in the enclosed circuit. The method further includes circulating the working medium through the enclosed circuit, and the circulation is driven by the differential heating and cooling of the working medium. The method also includes driving a turbine with the moving working medium. In some embodiments, the method further includes driving an electric generator from the turbine. The method may also include constricting the flow of the working medium as it passes the turbine, such that the velocity of the working medium as it passes the turbine is higher than in an unrestricted portion of the enclosed circuit. In some embodiments, constricting the flow of the working medium as it passes the turbine includes preventing the flow of the working medium near a rotational axis of the turbine using a compression ring. In some embodiments, the compression ring has a variable radius, and the method further includes adjusting the radius of the compression ring. The method may include insulating a portion of the enclosed circuit to mitigate heat loss from the enclosed circuit. Heating the working medium may include passing the working medium through a heat exchanger carrying a heated fluid. In some embodiments, heating the working medium includes providing heat to the working medium from a waste heat source.

### BRIEF DESCRIPTION OF THE DRAWINGS

FIG. 1 illustrates a power generation device according to embodiments.

FIG. 2 shows a portion of the power generation device of FIG. 1 in more detail.

FIG. 3 illustrates a power generation device according to other embodiments.

### DETAILED DESCRIPTION

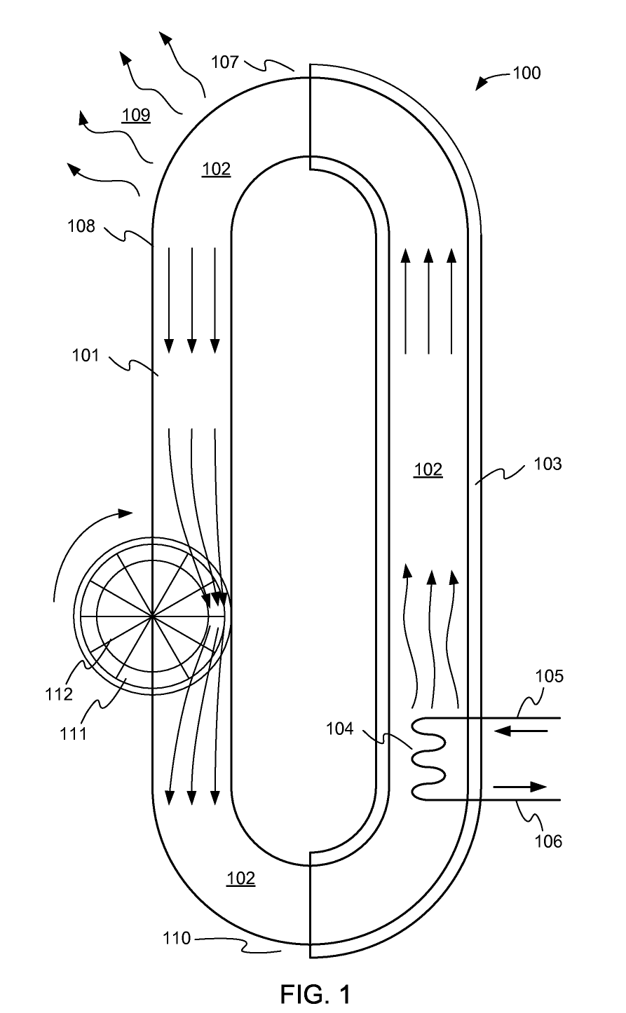

FIG. 1 illustrates a power generation device 100, in accordance with embodiments. Example power generation device 100 includes an enclosed tube 101, which is filled with a working medium 102. Working medium 102 may be, for example, a gas such as air, nitrogen, carbon dioxide, or another gas. For the purposes of illustration of this example, the working medium will be described as air, but it is to be understood that the claims are not so limited. The pressure inside tube 101 may be any suitable pressure, for example atmospheric pressure, or a pressure above or below atmospheric pressure. Tube 101 may be made of any suitable material, depending on its size, and on pressure and heat transfer requirements. Merely by way of example, tube 101 may be made of a metal such as steel or aluminum, of a polymer such as polyvinyl chloride (PVC), or a composite material. Different parts of tube 101 may be made of different materials.

Tube 101 may be sealed or substantially sealed at least to the degree that any leakage into or out of tube 101 does not significantly affect the performance of generation device 100. In some embodiments, for example when the pressure within tube 101 is higher or lower than that of the surrounding environment, tube 101 may be hermetically sealed. Tube 101 thus forms an enclosed circuit for the circulation of working medium 102. A portion of tube 101 may be insulated using insulation 103 to mitigate heat transfer through the tube wall to the environment outside of tube 101. Heat may be supplied to air 102 through a heat exchanger 104. For example, a heated fluid may enter heat exchanger 104 through an inlet pipe 105. Heat from the heated fluid may be imparted to air 102 by heat exchanger 104, and the fluid may then exit through an outlet pipe 106. The heated fluid flowing through heat exchanger 104 may result from any suitable source. For example, the heated fluid may be hot water that is wasted from an industrial process or other process, such as the cooling circuit of a traditional steam power plant. The heated fluid utilized in heat exchanger 104 could also be heated specifically for use with power generation device 100, for example by solar energy, geothermal energy, or may even be heated using fossil fuel in some embodiments. In other embodiments, a heat exchanger may not be used, and heat may be carried to the interior of tube 101 by another means to heat air 102. For example, a thermally conductive bar may conduct heat from an external heat source into the interior of tube 101, or the exterior of tube 101 may be heated directly so that air 102 is heated by contact with the interior wall of tube 101. Multiple heat sources may be provided. For example, when the primary heat source is solar energy, a backup heat source may be provided so that power can be generated during times when solar energy is not available, such as at night or during inclement weather.

In some embodiments, thermal storage may be provided that enables power generation on demand, even when the primary heat source is unavailable. For example, water or another thermal storage medium may be heated using solar energy during times when solar energy is available. Heat from the thermal storage medium may then be extracted to provide heat to power generation device 100. For example, the heated fluid flowing through heat exchanger 104 may obtain its heat from the thermal storage medium.

As air 102 is heated, its density decreases, its buoyancy increases, and it tends to rise within tube 101 toward top end 107 of device 100. In some embodiments, the side 108 of tube 101 opposite insulation 103 is uninsulated, and the environment outside tube 101 is at a lower temperature than air 102, so that heat 109 is lost from air 102, via conduction, convection, and radiation through and from tube 101. In other embodiments, active cooling may be supplied to cool air 102 in side 108 of tube 101. For example, an additional heat exchanger may be provided through which a relatively cold fluid is circulated, such as water from a nearby stream, water cooled in a ground-coupled piping loop, or from another source. In some embodiments, active cooling may be provided, for example using an absorption chiller driven from the same ultimate heat source from which heat exchanger 104 derives its heat. Cooling mechanisms other than those described herein may be utilized.

As air 102 on side 108 of tube 101 is cooled, its density increases, its buoyancy decreases, and it tends to fall toward bottom end 110 of tube 101. Thus, the differential heating and cooling of air 102 on the two sides of tube 101 and the resulting movement of air creates an air current circulating within tube 101. At least some of the thermal energy imparted to air 102 through heat exchanger 104 (or other heating device) has been converted to kinetic energy in the moving air.

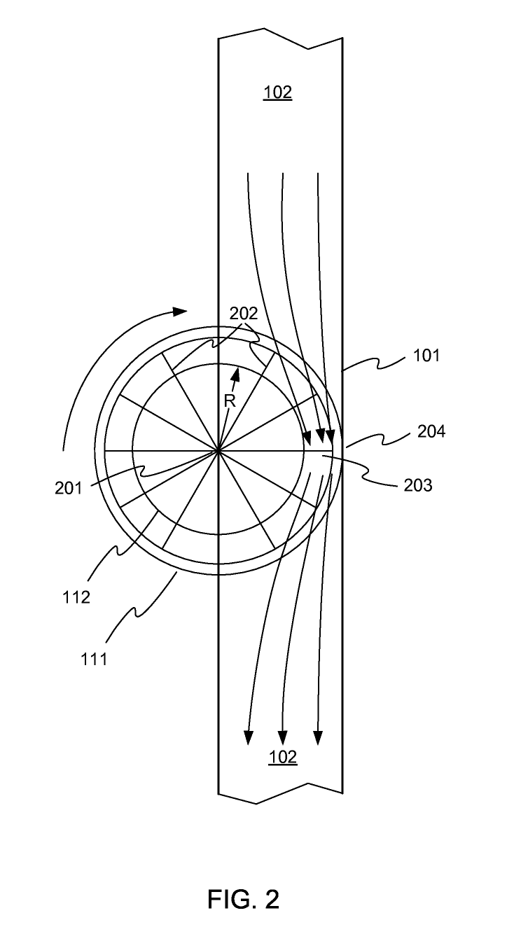

A turbine 111 is positioned at least partially within tube 101, and is driven by moving air 102 to drive an electric generator (not shown). Turbine 111 may be any suitable kind of turbine, but in some embodiments, includes a variable compression ring 112, the function of which is explained in more detail with reference to FIG. 2.

Example turbine 111 is mounted with its rotational axis 201 transverse to the flow of air 102 through tube 101. Turbine blades 202 (only two of which are labeled in FIG. 2) are contacted by the flowing air 102, which imparts torque to turbine 111, causing turbine 111 to rotate. Compression ring 112 prevents air 102 from flowing near the center of turbine 111, so all of the flow is directed through the throat 203 formed between compression ring 112 and wall area 204 of tube 101. Accordingly, the velocity of air 102 at throat 203 is greater than in the unrestricted tube sections above and below turbine 111. The faster-moving air may be more amenable for driving a turbine such as turbine 111 than the slower-moving air in the unrestricted tube sections. The radius R of compression ring 112 may be selected for optimum performance and power generation, and may be adjusted as operating conditions change, for example as more or less heat is available to drive the system.

Once air 102 has passed through turbine 111, it passes again to heat exchanger 104 in the insulated side of tube 101, and repeats the cycle through tube 101. That is, the air is heated and rises in the insulated section of tube 101, passes top end 107 of tube 101, cools and falls in side 108 of tube 101, drives turbine 111, and falls to bottom end 110 of tube 101. Thus, a portion the heat added to air 102 at heat exchanger 104 is converted to electric power generated by the generator (not shown) driven by turbine 111.

The system may be used for waste heat recovery or other applications. Especially when a free or low-cost heat source is used, the power generated by the system is obtained very cheaply. It is anticipated that the dimensions of the system are tailored to the available space and the particular application contemplated. In one experimental installation, tube 101 is circular in cross section, with a cross section diameter of about eight inches, and the height of the loop formed by tube 101 is about 10 feet from top end 107 to bottom end 110. Other cross sectional shapes may be used, and the system may be scaled up or down to any practicable size. It is anticipated that in some applications, tube 101 may be several meters or more in diameter, and device 100 may be tens of meters or more in height.

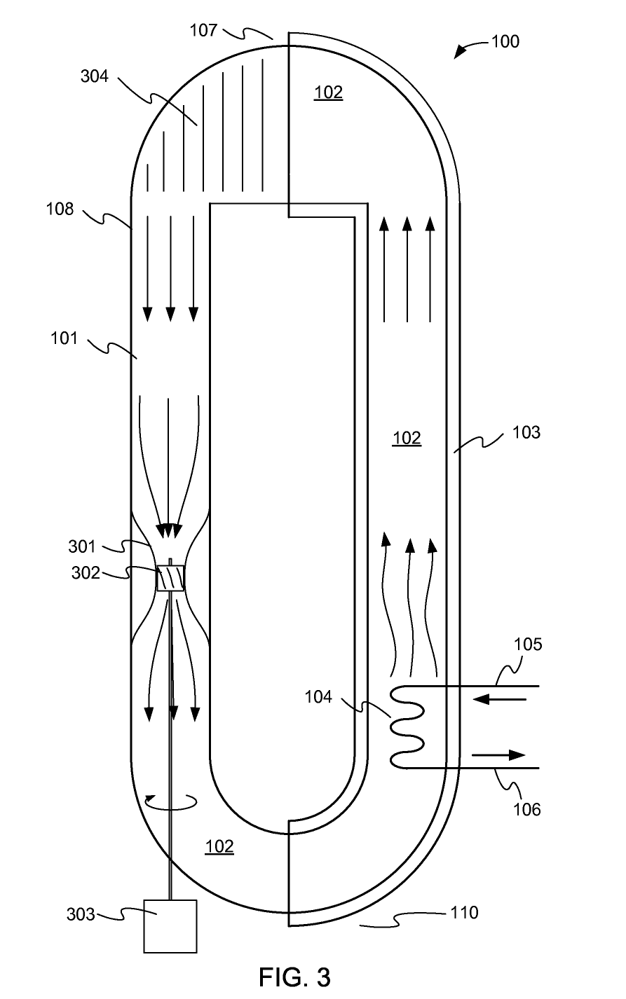

Many variations are possible within the scope of the appended claims. For example, an axial turbine disposed within tube 101 may be used. The turbine need not be of the same diameter as tube 101. For example, a constriction or nozzle may be placed in tube 101 to increase the velocity of the working medium as it passes the turbine. FIG. 3 illustrates an example of this arrangement. In the example of FIG. 3, nozzle 301 constricts the flow of air 102 to increase its velocity as it passes and drives axial turbine 302. Axial turbine 302 in turn drives electrical generator 303 to generate electric power. FIG. 3 also illustrates the use of a heat exchanger 304 for cooling of air 102.

The invention has now been described in detail for the purposes of clarity and understanding. However, it will be appreciated that other changes and modifications may be practiced within the scope of the appended claims.

What is claimed is:

1. A power generation system, comprising:
an enclosed circuit through which a working medium circulates;
a heat source that heats the working medium at a first location in the circuit;
a cooling mechanism that cools the working medium at a second location in the circuit;
wherein the differential heating and cooling causes the working medium to circulate within the enclosed circuit, and wherein the system further comprises;
a turbine driven by the circulating working medium.

2. The power generation system of claim 1, further comprising an electric generator driven by the turbine.

3. The power generation system of claim 1, further comprising a constriction through which the working medium passes, such that the velocity of the working medium is higher as it passes the turbine than in an unrestricted portion of the enclosed circuit.

4. The power generation system of claim 3, wherein the turbine comprises a rotational axis transverse to the flow of the working fluid through the enclosed circuit, and wherein the turbine comprises a compression ring that prevents the working medium from flowing near the rotational axis of the turbine.

5. The power generation system of claim 4, wherein the radius of the compression ring is variable.

6. The power generation system of claim 1, wherein the heat source is a heat exchanger that imparts heat to the working medium from a heated fluid.

7. The power generation system of claim 1, wherein at least one portion of the enclosed circuit is insulated to mitigate heat loss to the ambient environment surrounding the system.

8. The power generation system of claim 1, wherein the cooling mechanism comprises an uninsulated portion of the enclosed circuit, to enable heat loss to the ambient environment surrounding the system.

9. The power generation system of claim 1, wherein the working medium is air.

10. A method of generating electric power, the method comprising:
enclosing a working medium within an enclosed circuit;
heating the working medium at a first location in the enclosed circuit;
cooling the working medium at a second location in the enclosed circuit;
circulating the working medium through the enclosed circuit, the circulation being driven by the differential heating and cooling of the working medium; and
driving a turbine with the moving working medium.

11. The method of claim 10, further comprising driving an electric generator from the turbine.

12. The method of claim 10, further comprising constricting the flow of the working medium as it passes the turbine, such that the velocity of the working medium as it passes the turbine is higher than in an unrestricted portion of the enclosed circuit.

13. The method of claim 12, wherein constricting the flow of the working medium as it passes the turbine comprises preventing the flow of the working medium near a rotational axis of the turbine using a compression ring.

14. The method of claim 13, wherein the compression ring has a variable radius, and wherein the method further comprises adjusting the radius of the compression ring.

15. The method of claim 10, further comprising insulating a portion of the enclosed circuit to mitigate heat loss from the enclosed circuit.

16. The method of claim 10, wherein heating the working medium comprises passing the working medium through a heat exchanger carrying a heated fluid.

17. The method of claim 10, wherein heating the working medium comprises providing heat to the working medium from a waste heat source.
